(19) United States
(12) Patent Application Publication
(10) Pub. No.: US 2008/0256335 A1
(43) Pub. Date: Oct. 16, 2008

(54) MICROPROCESSOR, MICROCOMPUTER, AND ELECTRONIC INSTRUMENT

(75) Inventor: Hiroki MATSUOKA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/100,560

(22) Filed: Apr. 10, 2008

(30) Foreign Application Priority Data
Apr. 12, 2007 (JP) 2007-104847

(51) Int. Cl. G06F 9/38

(52) U.S. Cl. 712/205; 712/E09.045

(57) ABSTRACT

A microprocessor includes a pipeline control section which controls a pipeline process. The pipeline control section decodes an instruction code of an interrupt instruction and causes an immediate generation section to generate a vector address used for referring to information relating to a branch destination address corresponding to the interrupt instruction stored in a vector table based on a decoding result in a first instruction execution stage of the interrupt instruction. The pipeline control section controls the pipeline process so that the vector address is set in a pipeline register 1, a value of a stack pointer is set in a pipeline register 2, and a predetermined constant value is set in a pipeline register 3 at the end of the first instruction execution stage of the interrupt instruction.

Japanese Patent Application No. 2007-104847, filed on Apr. 12, 2007, is hereby incorporated by reference in its entirety.

### BACKGROUND OF THE INVENTION

The present invention relates to a microprocessor, a microcomputer, and an electronic instrument.

A microprocessor generally employs an architecture in which the microprocessor performs a pipeline process which divides an execution process of each instruction of a program into a plurality of steps completed in one clock cycle, and executes different steps of consecutive instructions in parallel to process the program at high speed. For example, a reduced instruction set computer (RISC) processor is known which speeds up the pipeline process by implementing a complex process using a combination of simple instruction sets in order to make the number of steps of each instruction identical to reduce the processing time required for each step. JP-B-8-1604 discloses technology in this field, for example.

Most microprocessors can implement an efficient pipeline process during normal operation. However, when an interrupt cause has occurred, an interrupt instruction is executed so that a branch to an interrupt handling program occurs, whereby the pipeline process is terminated. If interrupt handling takes time, the response of the program decreases. Therefore, it is necessary to reduce the execution time of an interrupt handling program and reduce the execution time of an interrupt instruction.

Execution of an interrupt instruction generally includes decoding the interrupt instruction, generating a branch destination address, saving the value of a program counter and status information in a stack, and jumping to the branch destination address.

Since the branch destination address differs depending on the interrupt cause, a correspondence table (vector table) between the interrupt cause and the branch destination address is provided. Therefore, when generating the branch destination address, it is necessary to generate an address (vector address) for referring to the vector table and read the branch destination address from a storage area referred to by the vector address.

When saving the value of the program counter and status information in the stack, it is necessary to update a stack pointer, output the value of the program counter to a data bus, save the value of the program counter in the stack, output the status information to the data bus, and save the status information in the stack.

A related-art microprocessor requires at least 2 to 3 clock cycles for generating the branch destination address, and requires at least 3 to 5 clock cycles for saving the value of the program counter and status information in the stack. Therefore, 7 to 10 clock cycles are required to execute the interrupt instruction.

The number of clock cycles required to execute the interrupt instruction can be reduced by additionally providing a dedicated circuit for executing the interrupt instruction. However, since the interrupt instruction is not executed frequently, it is not advantageous to additionally provide a dedicated circuit which increases cost.

### SUMMARY

According to a first aspect of the invention, there is provided a microprocessor which executes an instruction having an instruction code stored in a memory and has a function of performing a pipeline process including an instruction fetch stage for fetching the instruction code and an instruction execution stage for executing the instruction, the microprocessor comprising:

a pipeline control section which controls the pipeline process;

a program counter used for referring to a storage location of the instruction code;

a general-purpose arithmetic logic unit which executes an arithmetic calculation based on at least two inputs;

a stack pointer used for referring to a stack area in which a value of the program counter is saved;

a first pipeline register used for setting an address of a memory storing information relating to a branch destination address corresponding to an interrupt instruction which is executed by a plurality of instruction execution stages;

a second pipeline register used for setting a first input to the arithmetic logic unit; and

a third pipeline register used for setting a second input to the arithmetic logic unit,

wherein, in a first instruction execution stage of the interruption instruction, the pipeline control section decodes the instruction code of the interrupt instruction and causes a vector address for referring to the information relating to the branch destination address corresponding to the interrupt instruction to be generated based on a decoding result of the interrupt instruction; and

wherein the pipeline control section controls the pipeline process so that the vector address is set in the first pipeline register, the value of the stack pointer is set in the second pipeline register, and a predetermined constant value is set in the third pipeline register at the end of the first instruction execution stage of the interrupt instruction.

According to a second aspect of the invention, there is provided a microcomputer comprising the above-described microprocessor.

According to a third aspect of the invention, there is provided an electronic instrument comprising:

the above-described microcomputer;

an input section which inputs data to be processed by the microcomputer; and

an output section which outputs the data processed by the microcomputer.

### BRIEF DESCRIPTION OF THE SEVERAL VIEWS OF THE DRAWING

FIG. 1 is a diagram showing a configuration example of part of a microprocessor according to one embodiment of the invention.

FIG. 2 is a diagram illustrative of a configuration example of a state register.

FIG. 3 is a diagram illustrative of a configuration example of a vector table.

FIG. 4 is a diagram illustrative of a configuration example of an instruction code of an interrupt instruction.

FIG. 5 is a diagram illustrative of an operation of a microprocessor according to one embodiment of the invention when a software interrupt has occurred.

FIG. 6 is a diagram illustrative of an operation of saving values of a program counter and a state register in a stack area when executing an interrupt.

FIG. 7 shows an example of a hardware block diagram of a microcomputer according to one embodiment of the invention.

FIG. 8 shows an example of a block diagram of an electronic instrument including an integrated circuit device.

FIGS. 9A to 9C show examples of outside views of various electronic instruments.

### DETAILED DESCRIPTION OF THE EMBODIMENT

The invention may provide a microprocessor which executes an interrupt instruction at high speed effectively utilizing a pipeline process circuit, a microcomputer, and an electronic instrument.

(1) According to one embodiment of the invention, there is provided a microprocessor which executes an instruction having an instruction code stored in a memory and has a function of performing a pipeline process including an instruction fetch stage for fetching the instruction code and an instruction execution stage for executing the instruction, the microprocessor comprising:

a pipeline control section which controls the pipeline process;

a program counter used for referring to a storage location of the instruction code;

a general-purpose arithmetic logic unit which executes an arithmetic calculation based on at least two inputs;

a stack pointer used for referring to a stack area in which a value of the program counter is saved;

a first pipeline register used for setting an address of a memory storing information relating to a branch destination address corresponding to an interrupt instruction which is executed by a plurality of instruction execution stages;

a second pipeline register used for setting a first input to the arithmetic logic unit; and

a third pipeline register used for setting a second input to the arithmetic logic unit,

wherein, in a first instruction execution stage of the interruption instruction, the pipeline control section decodes the instruction code of the interrupt instruction and causes a vector address for referring to the information relating to the branch destination address corresponding to the interrupt instruction to be generated based on a decoding result of the interrupt instruction; and

wherein the pipeline control section controls the pipeline process so that the vector address is set in the first pipeline register, the value of the stack pointer is set in the second pipeline register, and a predetermined constant value is set in the third pipeline register at the end of the first instruction execution stage of the interrupt instruction.

The memory which stores the instruction code may be a read-only memory (ROM), for example.

The number of instruction execution stages may differ corresponding to each instruction.

In the case of a software interrupt, an instruction code of an interrupt instruction may be stored in the memory in advance, for example. In the case of a hardware interrupt, an instruction code of an interrupt instruction containing an interrupt cause may be generated.

The memory which stores the information relating to the branch destination address corresponding to the interrupt instruction may be provided inside or outside of the microprocessor according to this embodiment.

The pipeline register is used for setting information necessary for a process in the next stage of the pipeline process.

A component for generating the vector address may be an immediate generation section which generates an immediate address or immediate data, a general-purpose arithmetic logic unit, or a dedicated component which generates the vector address.

When the stack area is allocated in a memory which allows at least byte access and word access, the predetermined constant value may be a value obtained by dividing the number of bits corresponding to one word by the number of bits corresponding to one byte, for example. For example, when one word is 32 bits, the predetermined constant value may be four.

According to this embodiment, the instruction code can be decoded and the vector address can be generated in the first instruction execution stage of the interrupt instruction. According to this embodiment, the address (vector address) of the memory at which the information relating to the branch destination address is stored and the arithmetic calculation input for updating the stack pointer can be set in each pipeline register at the end of the first instruction execution stage of the interrupt instruction. Therefore, the number of clock cycles required to execute the interrupt instruction can be reduced.

(2) This microprocessor may further comprise:

an immediate generation section which generates an immediate address or immediate data,

the pipeline control section causing the immediate generation section to generate the vector address in the first instruction execution stage of the interrupt instruction.

According to this embodiment, since the vector address is generated using the immediate generation section in the first instruction execution stage of the interrupt instruction, the area and cost can be reduced as compared with the case of using a dedicated circuit.

(3) This microprocessor may further comprise;

a signal path connecting an output of the immediate generation section and an input of the first pipeline register;

a signal path connecting an output of the first pipeline register and an address input of the memory storing the information relating to the branch destination address;

a signal path connecting an output of the stack pointer and an input of the second pipeline register;

a signal path connecting an output of the second pipeline register and the first input of the arithmetic logic unit;

a signal path connecting a supply source of the predetermined constant value and an input of the third pipeline register; and

a signal path connecting an output of the third pipeline register and the second input of the arithmetic logic unit.

According to this embodiment, since the signal path connecting the output of the immediate generation section and the input of the first pipeline register and the signal path connecting the output of the first pipeline register and the address input of the memory which stores the information relating to the branch destination address are provided, the vector address generated by the immediate generation section can be supplied to the address input of the memory in one clock cycle. According to this embodiment, since the signal path connecting the output of the stack pointer and the input of the second pipeline register and the signal path connecting the output of the second pipeline register and the first input of the arithmetic logic unit are provided, the value of the stack pointer can be supplied to the first input of the arithmetic logic unit in one clock cycle. According to this embodiment, since the signal path connecting the supply source of the predetermined constant value and the input of the third pipeline register and the signal path connecting the output of the third pipeline register and the second input of the arithmetic logic unit are provided, the predetermined constant value can be supplied to the second input of the arithmetic logic unit in one clock cycle. Therefore, the number of clock cycles required to execute the interrupt instruction can be reduced.

(4) This microprocessor may further comprise:

a general-purpose data bus,

wherein an nth (n is 1, 2, or 3) pipeline register among the first to the third pipeline registers is used for supplying data to at least part of the general-purpose data bus;

wherein the pipeline control section causes the arithmetic logic unit to execute an arithmetic calculation based on the value of the stack pointer and the predetermined constant value in a second instruction execution stage of the interrupt instruction; and

wherein the pipeline control section controls the pipeline process so that a result of the arithmetic calculation is set in the stack pointer, the value of the program counter is set in the nth pipeline register, and the information relating to the branch destination address referred to by the vector address is set in the program counter at the end of the second instruction execution stage of the interrupt instruction.

The arithmetic calculation may be addition or subtraction, for example. For example, when the stack area is allocated in a memory of which four bytes correspond to one word, the predetermined constant value may be four, and the arithmetic logic unit may subtract four from the value of the stack pointer.

According to this embodiment, the updated value of the stack pointer can be calculated from the value of the stack pointer and the predetermined constant value in the second instruction execution stage of the interrupt instruction. According to this embodiment, it is possible to update the stack pointer, set the value of the program counter in the nth pipeline register (supply the value of the program counter to at least part of the general-purpose data bus), and set the information relating to the branch destination address in the program counter at the end of the second instruction execution stage of the interrupt instruction. According to this embodiment, since the value of the program counter is set in the nth pipeline register, the information relating to the branch destination address can be set in the program counter before saving the value of the program counter in the stack area. Therefore, the number of clock cycles required to execute the interrupt instruction can be reduced. Since the updated value of the stack pointer is calculated using the general-purpose arithmetic logic unit, the area and cost can be reduced as compared with the case of using a dedicated circuit.

(5) This microprocessor may further comprise:

a signal path connecting an output of the program counter and an input of the nth pipeline register; and

a signal path connecting an output of the nth pipeline register and the at least part of the general-purpose data bus.

According to this embodiment, since the signal path connecting the output of the program counter and the input of the nth pipeline register and the signal path connecting the output of the nth pipeline register and at least part of the general-purpose data bus are provided, the value of the program counter can be supplied to the general-purpose data bus in one clock cycle. Therefore, the number of clock cycles required to execute the interrupt instruction can be reduced.

(6) This microprocessor may further comprise;

a general-purpose data bus;

a fourth pipeline register used for supplying data to at least part of the general-purpose data bus;

a signal path connecting an output of the program counter and an input of the fourth pipeline register; and

a signal path connecting an output of the fourth pipeline register and the at least part of the general-purpose data bus,

wherein the pipeline control section causes the arithmetic logic unit to execute an arithmetic calculation based on the value of the stack pointer and the predetermined constant value in a second instruction execution stage of the interrupt instruction; and

wherein the pipeline control section controls the pipeline process so that a result of the arithmetic calculation is set in the stack pointer, the value of the program counter is set in the fourth pipeline register, and the information relating to the branch destination address referred to by the vector address is set in the program counter at the end of the second instruction execution stage of the interrupt instruction.

According to this embodiment, the updated value of the stack pointer can be calculated from the value of the stack pointer and the predetermined constant value in the second instruction execution stage of the interrupt instruction. According to this embodiment, it is possible to update the stack pointer, set the value of the program counter in the fourth pipeline register, and set the information relating to the branch destination address in the program counter at the end of the second instruction execution stage of the interrupt instruction. According to this embodiment, since the value of the program counter is set in the fourth pipeline register, the information relating to the branch destination address can be set in the program counter before saving the value of the program counter in the stack area. Therefore, the number of clock cycles required to execute the interrupt instruction can be reduced. Since the updated value of the stack pointer is calculated using the general-purpose arithmetic logic unit, the area and cost can be reduced as compared with the case of using a dedicated circuit.

According to this embodiment, since the signal path connecting the output of the program counter and the input of the fourth pipeline register and the signal path connecting the output of the fourth pipeline register and at least part of the general-purpose data bus are provided, the value of the program counter can be supplied to the general-purpose data bus in one clock cycle. Therefore, the number of clock cycles required to execute the interrupt instruction can be reduced. According to this embodiment, since the signal path connecting the output of the fourth pipeline register and the general-purpose data bus is provided, desired data can be supplied to the general-purpose data bus without using the first to third pipeline registers. For example, data can be supplied to the general-purpose data bus and an input can be supplied to the arithmetic logic unit in a single execution stage. Therefore, the number of execution cycles can also be reduced when executing an instruction other than the interrupt instruction.

(7) This microprocessor may further comprise:

a state register which indicates a state of the microprocessor,

the pipeline control section controlling the pipeline process so that the value of the program counter set in the pipeline register and a value of the state register are written into the stack area in a third instruction execution stage of the interrupt instruction.

According to this embodiment, the value of the program counter and the value of the state register can be simultaneously saved in the stack area in the third instruction execution stage of the interrupt instruction. Therefore, the number of clock cycles required to execute the interrupt instruction can be reduced.

(8) This microprocessor may further comprise:

a signal path connecting an output of the state register and the at least part of the general-purpose data bus; and

a signal path connecting the general-purpose data bus and a data input of a memory having the stack area.

According to this embodiment, since the signal path connecting the output of the state register and at least part of the general-purpose data bus and the signal path connecting the general-purpose data bus and the data input of the memory having the stack area are provided, data on the general-purpose data bus can be supplied to the data input of the memory having the stack area in one clock cycle. Therefore, the number of clock cycles required to execute the interrupt instruction can be reduced.

(9) In this microprocessor,

the program counter having a bit width of i bits (i is an integer equal to or larger than one);

the state register having a bit width of j bits (j is an integer equal to or larger than one);

a memory having the stack area having an input data bus with a k-bit width (k is an integer equal to or larger than one); and

k being equal to or larger than i+j.

For example, the program counter may have a bit width of 24 bits, the state register may have a bit width of 8 bits, and the input data bus of the memory having the stack area may have a bit width of 32 bits.

According to this embodiment, since the number of bits of the input data bus of the memory having the stack area is equal to or larger than the sum of the number of bits of the program counter and the number of bits of the state register, the value of the program counter and the value of the state register can be saved in the stack area in one clock cycle. Therefore, the number of clock cycles required to execute the interrupt instruction can be reduced.

(10) In this microprocessor,

a memory having the stack area having an input data bus with a k-bit width (k is an integer equal to or larger than one); and

the stack pointer referring to the stack area by designating an address of a k-bit boundary.

The address of the k-bit boundary may be an address which allows k-bit data to be written into the memory having the stack area and the input data bus with a k-bit width in one clock cycle. For example, when a memory in which addresses are assigned in units of 1-byte (8-bit) storage areas has a 32-bit input data bus, 32-bit data is stored in the storage areas corresponding to four addresses. Therefore, the address of a 32-bit boundary may be an address of which the lower-order two bits are zero, for example.

According to this embodiment, k-bit data can be written into the stack area in one clock cycle. Therefore, when the sum of the number of bits of the program counter and the number of bits of the state register is equal to or less than k, the value of the program counter and the value of the state register can be saved in the stack area in one clock cycle.

(11) According to one embodiment of the invention, there is provided a microcomputer comprising the above-described microprocessor.

(12) According to one embodiment of the invention, there is provided an electronic instrument comprising:

the above-described microcomputer;

an input section which inputs data to be processed by the microcomputer; and

an output section which outputs the data processed by the microcomputer.

Some embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Microprocessor

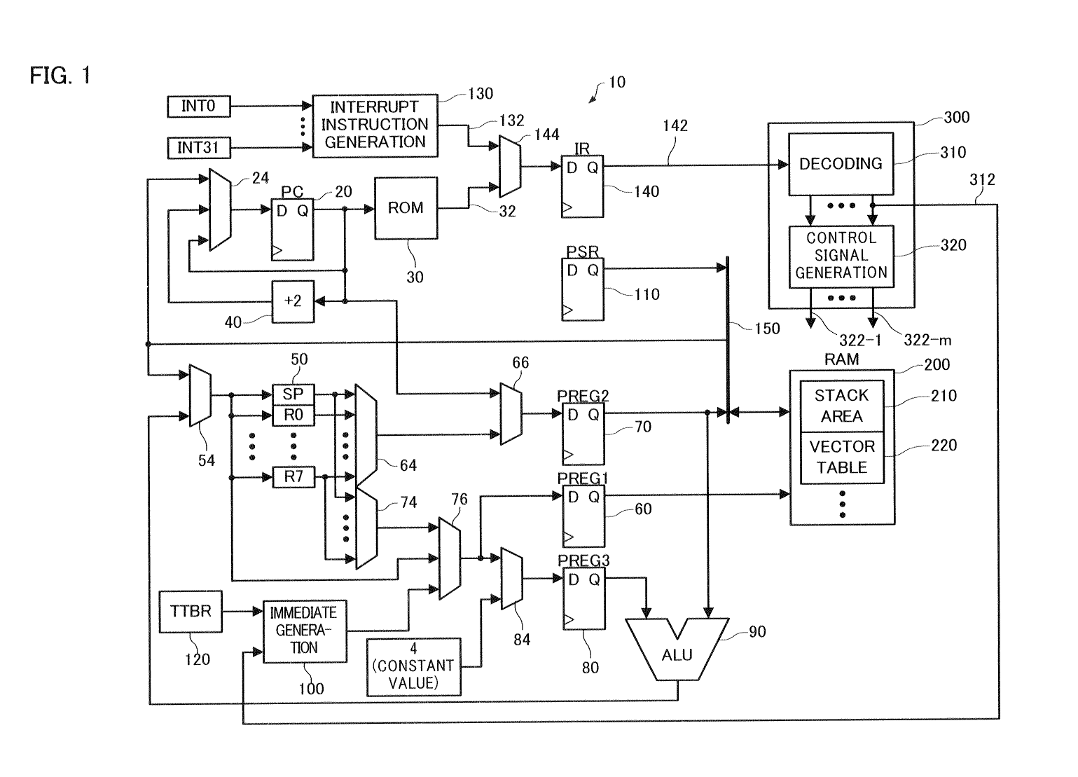

FIG. 1 is a diagram illustrative of a configuration example of part of a microprocessor according to one embodiment of the invention. FIG. 1 shows a circuit configuration example of a portion relating to interrupt handling included in the microprocessor according to this embodiment.

A RAM 200 is a 32 kilobyte (KB) RAM, for example. The RAM 200 is mapped at 0x000000 to 0x007FFF in a 24-bit address space. The RAM 200 allows byte access (8-bit access) and word access (32-bit access) in at least one clock cycle. The RAM 200 is configured so that word boundaries (32-bit boundaries) are set every four bytes (lower-order two bits of 24-bit addresses are 00 to 11). 1-word (32-bit) data can be written or read in one clock cycle by word access which designates the address (address of which the lower-order two bits are 00) at the word boundary (32-bit boundary). The RAM 200 may be an internal memory of a microprocessor 10, or may be an external memory.

The microprocessor 10 includes a 24-bit program counter 20. The output of the program counter 20 is connected to an address input of a ROM 30. The program counter 20 is used for referring to the ROM 30. The ROM 30 is a 64 KB ROM, for example. The ROM 30 is mapped at 0x010000 to 0x01FFFF in the 24-bit address space. The ROM 30 stores a plurality of instruction codes in order from the head address. For example, each instruction code has a 16-bit fixed length, and is stored at two consecutive addresses. The input of the program counter 20 is connected to the output of a 3-to-1 selector 24. The program counter 20 is updated by the output from the 3-to-1 selector 24 at the rising edge of a clock signal (not shown). The inputs of the 3-to-1 selector 24 are connected to the output of the program counter 20, the output of an incrementer 40, and the lower-order 24 bits of a 32-bit general-purpose data bus 150, respectively. The 3-to-1 selector 24 selects the output of the program counter 20, the output of the incrementer 40, or data on the general-purpose data bus 150 based on each instruction code, and supplies the selected data to the input of the program counter 20. For example, when reading the instruction codes stored in the ROM 30 in address order, the 3-to-1 selector 24 selects the output from the incrementer 40. For example, when the ROM 30 stores each instruction code at two consecutive addresses, the incrementer 40 outputs a value obtained by incrementing the value of the program counter 20 by two. For example, when suspending reading of the next instruction code stored in the ROM 30, the 3-to-1 selector 24 selects the output from the program counter 20. For example, when setting a branch destination address of a branch instruction in the program counter 20, the 3-to-1 selector 24 selects the lower-order 24 bits of the general-purpose data bus 150.

Eight 24-bit general-purpose registers R0 to R7 are used when executing each instruction code. Be microprocessor 10 includes a 24-bit stack pointer (SP) 50. The stack pointer 50 is used for referring to the address of a stack area 210 provided in the RAM 200. The inputs of the general-purpose registers R0 to R7 and the stack pointer 50 are connected to the output of a 2-to-1 selector 54. One input of the 2-to-1 selector 54 is connected to the lower-order 24 bits of the general-purpose data bus 150, and the other input of the 2-to-1 selector 54 is connected to the output of an arithmetic logic unit (ALU) 90. The 2-to-1 selector 54 selects lower-order 24-bit data on the general-purpose data bus 150 or the output from the ALU 90 based on each instruction code, and supplies the selected data to the inputs of the general-purpose registers R0 to R7 and the stack pointer 50. The inputs of the general-purpose registers R0 to R7 and the stack pointer 50 are connected to the inputs of a 9-to-1 selector 64 and a 9-to-1 selector 74. The outputs of the 9-to-1 selector 64 and the 9-to-1 selector 74 are respectively connected to the inputs of a 2-to-1 selector 66 and a 3-to-1 selector 76. The other input of the 2-to-1 selector 66 is connected to the output of the program counter 20. The remaining two inputs of the 3-to-1 selector 76 are connected to the output of the 2-to-1 selector 54 and the output of an immediate generation section 100. The output of the 2-to-1 selector 66 is connected to a data input of a pipeline register 2 PREG2) (70). The output of the 3-to-1 selector 76 is connected to a data input of a pipeline register 1 (PREG1) (60) and one input of a 2-to-1 selector 84. A constant value 4 is supplied to the other input of the 2-to-1 selector 84. The output of the 2-to-1 selector 84 is connected to a data input of a pipeline register 3 (PREG3) (80). The 9-to-1 selector 64 and the 2-to-1 selector 66 select the output from one of the general-purpose registers R0 to R7, the output from the stack pointer 50, or the output from the program counter 20 based on each instruction code, and supply the selected data to the data input of the pipeline register 2 (70). The 9-to-1 selector 74 and the 3-to-1 selector 76 select the output from one of the general-purpose registers R0 to R7, the output from the stack pointer 50, the output from the 2-to-1 selector 54, or the output from the immediate generation section 100 based on each instruction code, and supply the selected data to the data input of the pipeline register 1 (60). The 9-to-1 selector 74, the 3-to-1 selector 76, and the 2-to-1 selector 84 select the output from one of the general-purpose registers R0 to R7, the output from the stack pointer 50, the output from the 2-to-1 selector 54, the output from the immediate generation section 100, or the constant value 4 based on each instruction cede, and supply the selected data to the data input of the pipeline register 3 (80).

The immediate generation section 100 generates an immediate address or immediate data based on each instruction code. When executing an interrupt instruction, the output from a 17-bit trap table base register (TTBR) 120 and a 5-bit vector code (interrupt number) 312 are supplied to the immediate generation section 100. A base address of a vector table is set in the TTBR 120. The vector code 312 is allocated to 5 bits of an instruction code of an interrupt instruction. A decoding section 310 decodes an interrupt instruction and outputs the vector code 312. When executing an interrupt instruction, the immediate generation section 100 combines the output from the TTBR 120 and the vector code 312, and adds zero to the lower-order two bits of the resulting data to generate a 24-bit vector address.

The microprocessor 10 includes the pipeline register 1 (60) (first pipeline register), the pipeline register 2 (70) (second pipeline register), and the pipeline register 3 (80) (third pipeline register). The pipeline register 1 (60), the pipeline register 2 (70), and the pipeline register 3 (80) are 24-bit registers, for example, and are used for implementing a pipeline process.

The output of the pipeline register 1 (60) is connected to an address input of the RAM 200. The pipeline register 1 (60) is used for setting the address of the RAM 200. The stack area 210 is allocated to the RAM 200 in addition to a general-purpose data storage area (not shown). A vector table 220 is stored in the RAM 200. The stack area 210 is used for saving the value of the program counter 20 when executing a branch instruction. The stack area 210 is also used for saving the value of the program counter 20 and the value of a state register 110 when executing an interrupt instruction. Therefore, when executing a branch instruction or an interrupt instruction, the value of the stack pointer 50 is set in the pipeline register 1 (60) at a predetermined timing. The vector table 220 contains information relating to a branch destination address of an interrupt handling routine corresponding to an interrupt instruction. Therefore, when executing an interrupt instruction, a vector address for referring to the information relating to the branch destination address is set in the pipeline register 1 (60) at a predetermined timing.

The data input/output of the RAM 200 is connected to the general-purpose data bus 150. The output of the pipeline register 2 (70) is connected to the general-purpose data bus 150. The pipeline register 2 (70) is used for supplying data to at least part (e.g., lower-order 24 bits) of the 32-bit general-purpose data bus 150. The output of the pipeline register 2 (70) is connected to a first input of the ALU 90. The pipeline register 2 (70) is used for setting the first input of the ALU 90. Specifically, the pipeline register 2 (70) is a pipeline register for setting data supplied to the general-purpose data bus 150 or first input data of the ALU 90.

The output of the pipeline register 3 (80) is connected to a second input of the ALU 90. The pipeline register 3 (80) is used for setting the second input of the ALU 90.

The microprocessor 10 includes the ALU 90. The ALU 90 is a general-purpose arithmetic logic unit which executes arithmetic calculations based on at least two pieces of input data. For example, the ALU 90 performs arithmetic calculations (e.g., addition, subtraction, multiplication, and logical calculations) on two pieces of 24-bit input data, and outputs a 24-bit calculation result. The output of the ALU 90 is connected to one input of the 2-to-1 selector 54. Therefore, the calculation result of the ALU 90 can be stored in one of the general-purpose registers R0 to R7 or the stack pointer 50 through the 2-to-1 selector 54. The calculation result of the ALU 90 can also be stored in the pipeline register 1 (60) through the 2-to-1 selector 54 and the 3-to-1 selector 76. The calculation result of the ALU 90 can also be stored in the pipeline register 3 (80) through the 2-to-1 selector 54, the 3-to-1 selector 76, and the 2-to-1 selector 84.

The output of the pipeline register 2 (70), the data input/output of the RAM 200, the output of the state register 110, one input of the 2-to-1 selector 24, and one input of the 2-to-1 selector 54 are connected to the general-purpose data bus 150. The state register 110 is an 8-bit register which indicates a state of the microprocessor. Only one of the output of the pipeline register 2 (70), the output of the state register 110, and the output of the RAM 200 is supplied to the general-purpose data bus 150. Since the general-purpose data bus 150 is a 32-bit data bus, the output from the pipeline register 2 (70) can be supplied to the lower-order 24 bits of the general-purpose data bus 150 while supplying the output from the state register 110 to the higher-order eight bits of the general-purpose data bus 150, for example.

When a hardware interrupt due to one of thirty-two interrupt causes (interrupt numbers 0 to 31) has occurred, an interrupt instruction generation section 130 generates a 16-bit instruction code 132 of an interrupt instruction based on interrupt signals INTO to INT31 generated corresponding to the interrupt numbers 0 to 31, for example. The output of the interrupt generation section 130 is connected to one input of a 2-to-1 selector 144. A data output of the ROM is connected to the other input of the 2-to-1 selector 144. The output of the 2-to-1 selector 14 is connected to the input of a 16-bit instruction fetch register 140. The 2-to-1 selector 144 selects an instruction code 32 read from the ROM 30 or the instruction code 132 generated by the interrupt instruction generation section 130, and supplies the selected instruction code to the input of the instruction fetch register 140. For example, when a hardware interrupt has occurred, the 2-to-1 selector 144 selects the instruction code 132 generated by the interrupt instruction generation section 130. On the other hand, when a hardware interrupt has not occurred, the 2-to-1 selector 144 selects the instruction code 32 read from the ROM 30. The output from the 2-to-1 selector 144 is input to the instruction fetch register at the rising edge of the clock signal (not shown) so that the instruction code is fetched.

The microprocessor 10 includes a pipeline control section 300. When executing each instruction of which the instruction code is stored in the ROM 20 (memory), the pipeline control section 300 controls a pipeline process including an instruction fetch stage for fetching the instruction code and one or more instruction execution stages for executing each instruction. The pipeline control section 300 may include the decoding section 310 and a control signal generation section 320. The input of the decoding section 310 is connected to the output of the instruction fetch register 140. The decoding section 310 decodes an output 142 (fetched instruction code) from the instruction fetch register 140 to decode the instruction. The control signal generation section 320 generates control signals 322-1 to 322-m for controlling the pipeline process on each instruction based on the output (decoding result) from the decoding section 310. The control signals 322-1 to 322-m include selection signals supplied to the selectors 24, 54, 64, 66, 74, 76, 84, and 144, write signals supplied to the general-purpose registers R0 to R7, the stack pointer 50, and the pipeline registers 1, 2, and 3 (60, 70, and 80), an arithmetic calculation selection signal supplied to the ALU 90, output control signals supplied to the pipeline register 2 (70), the state register 110, and the general-purpose data bus 150 of the RAM 200, a write enable signal supplied to the RAM 200, and the like.

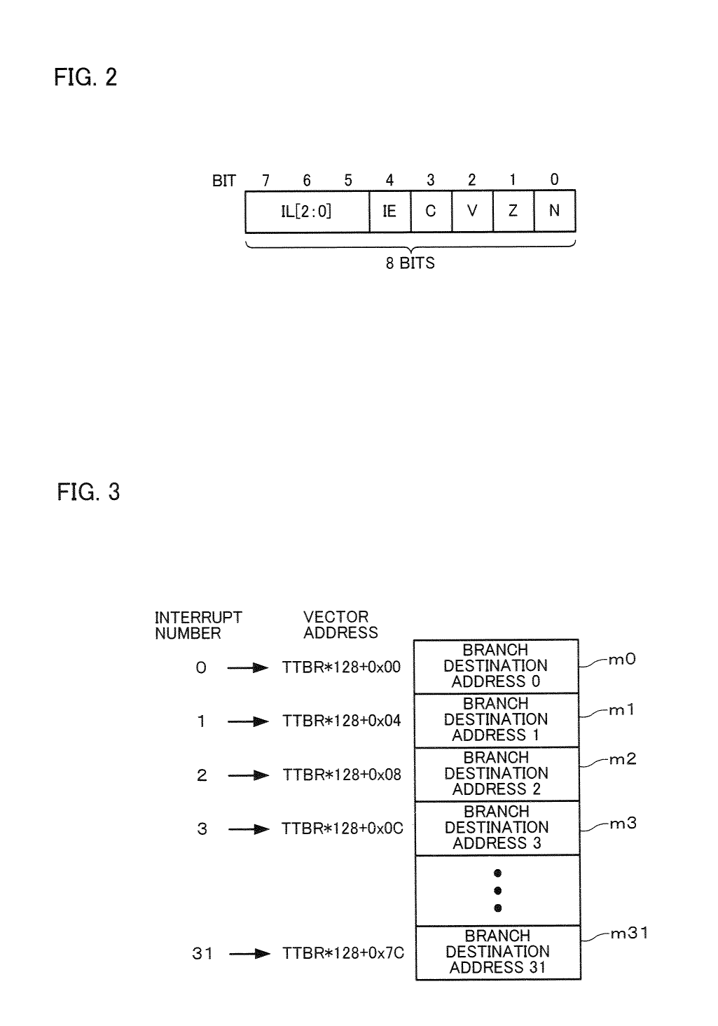

FIG. 2 is a diagram illustrative of a configuration example of the state register. The state register 110 is an 8-bit register which indicates a state of the microprocessor, for example. The following state indications of the microprocessor are respectively assigned to bits 7 to 0 of the state register 110, for example. IL[2:0] (interrupt level) bits assigned to bits 7 to 5 indicate the interrupt priority level. Only an interrupt with a degree of priority higher than the value set in the IL[2:0] bits is accepted. An interrupt enable (E) bit assigned to bit 4 determines whether or not to accept an external interrupt. For example, an external interrupt is accepted when the IE bit is set at “1”. A carry (C) bit assigned to bit 3 is set at “1” when carrying or borrowing occurs during arithmetic calculations of the ALU 90. An overflow (V) bit assigned to bit 2 is set at “1” when an overflow or underflow occurs during arithmetic calculations of the ALU 90. A zero (Z) bit assigned to bit 1 is set at “1” when the output from the ALU 90 is set at “0”. A negative (N) bit assigned to bit 0 coincides with a sign bit (most significant bit (bit 23)) of the output from the ALU 90.

FIG. 3 is a diagram illustrative of a configuration example of the vector table. The vector table 220 has storage areas m0 to m31 which store branch destination addresses 0 to 31 corresponding to the interrupt numbers 0 to 31. The storage areas m0 to m31 are respectively assigned to the addresses TTBRx128+0x00 to TTBRx128+0x7C of the word (32 bits) boundaries. For example, when the value of the TTBR is 0x0007E, the storage areas m0 to m31 are respectively assigned to addresses 0x003F00 to 0x003F7C.

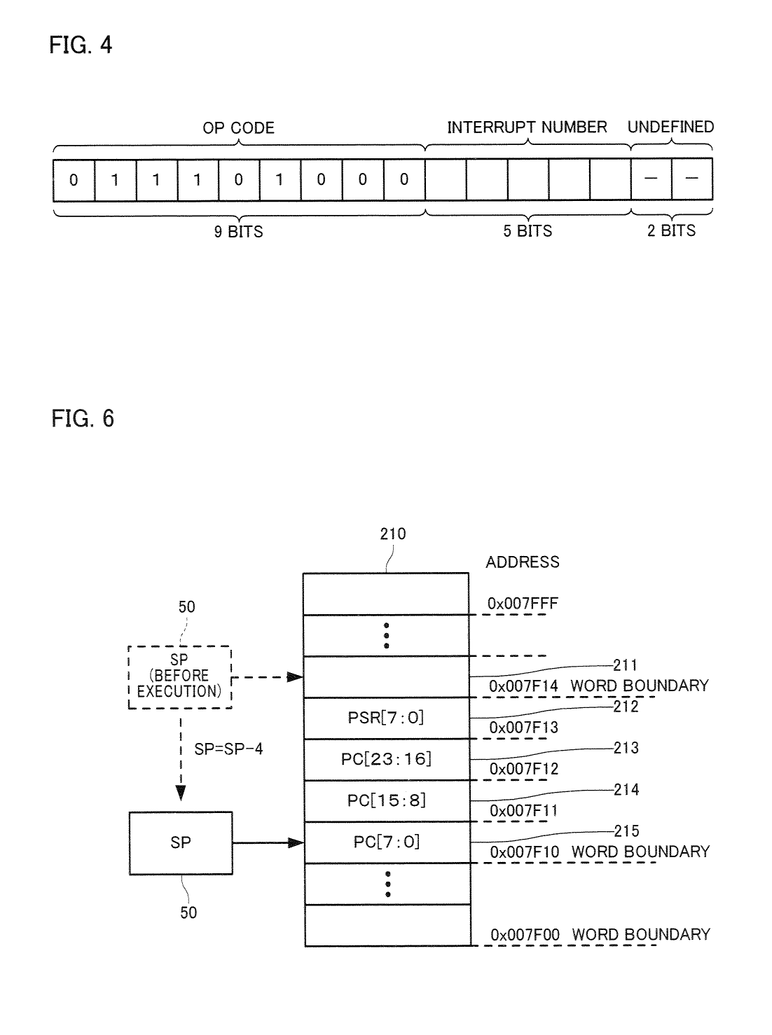

FIG. 4 is a diagram illustrative of a configuration example of an instruction code of an interrupt instruction. The interrupt instruction causes the value of the program counter and the value of the state register to be saved in the stack area, and causes a branch to the start address of an interrupt handling routine provided corresponding to each interrupt cause. The instruction cede of the interrupt instruction has a 16-bit field, for example. An OP code for identifying the type of instruction is assigned to the higher-order 9-bit field (i.e., bits 15 to 7), for example. The OP code of the interrupt instruction is 0x0E8, for example. One of the interrupt numbers 0 to 31 (i.e., 0x00 to 0x1F) is provided in the 5-bit field from bit 6 to bit 2, for example. The lower-order two bits are not defined, for example.

When a software interrupt has occurred, the decoding section 310 of the pipeline control section 300 decodes the instruction code 142, and determines that the instruction is an interrupt instruction when the higher-order nine bits of the instruction are 0x0E8. The decoding section 310 outputs bits 6 to 2 of the instruction code 142 as the vector code 312, for example.

When a hardware interrupt has occurred due to one of the thirty-two interrupt causes (interrupt numbers 0 to 31), the interrupt instruction generation section 130 sets the higher-order nine bits from bit 15 to bit 7 at 0x0E8, and sets the interrupt number corresponding to the hardware interrupt in bits 6 to 2 to generate the instruction code 132 of the interrupt instruction, for example.

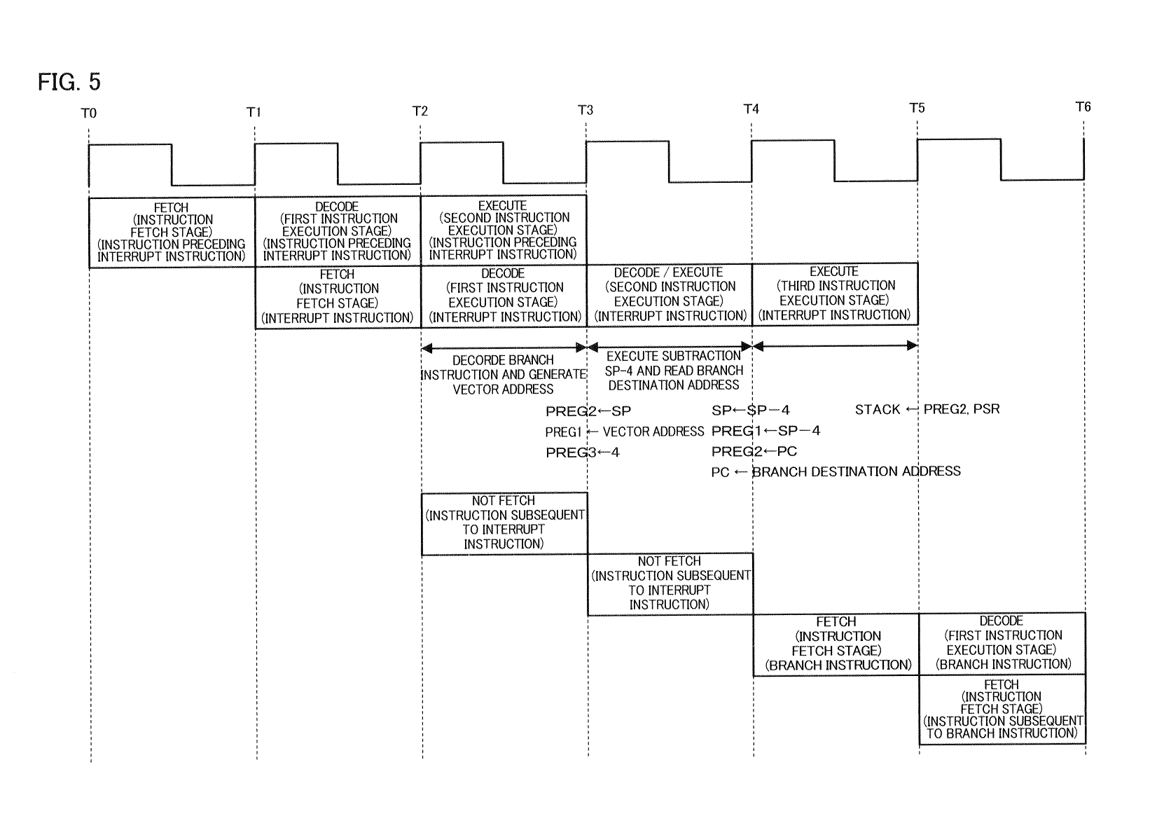

FIG. 5 is a diagram illustrative of the operation of the microprocessor according to this embodiment when a software interrupt has occurred. The interrupt operation shown in FIG. 5 is described below with reference to FIG. 1. Note that the pipeline control section 300 (control signal generation section 320) generates the selection signal so that the selector 144 selects the instruction code 32 read from the ROM 30 at times T0 to T6. The instruction code 32 is output from the selector 144.

The program counter 20 is updated at the rising edge of the clock signal at time T0. An address where the instruction code of the instruction preceding the interrupt instruction is stored is set in the program counter 20 so that the instruction code of the instruction preceding the interrupt instruction is read from the ROM 30. The pipeline control section 300 (control signal generation section 320) generates the selection signal in the period between times T0 and T1 so that the selector 24 selects the output from the incrementer 40. A calculation result obtained by incrementing the value of the program counter 20 by two is output from the selector 24. The instruction code of the instruction preceding the interrupt instruction is stored in the instruction fetch register 140 at the rising edge of the clock signal at time T1. The period between times T0 and T1 corresponds to the instruction fetch stage of the instruction preceding the interrupt instruction.

The value of the program counter 20 is incremented by two (+2) at the rising edge of the clock signal at time T1. As a result, the address where the instruction code of the interrupt instruction is stored is set in the program counter 20 so that the instruction code of the interrupt instruction is read from the ROM 30. The pipeline control section 300 (control signal generation section 320) generates the selection signal in the period between times T0 and T1 so that the selector 24 selects the output from the incrementer 40. A calculation result obtained by incrementing the value of the program counter 20 by two is output from the selector 24. The pipeline control section 300 decodes the instruction code (instruction code of the instruction preceding the interrupt instruction) stored in the instruction fetch register 140, and generates the control signals 322-1 to 322-m based on the decoding results. For example, when the instruction preceding the interrupt instruction is an arithmetic calculation instruction, the control signals 322-1 to 322-m which control the selectors 54, 64, 66, 74, 76, 84 and the like are generated so that the ALU 90 can execute arithmetic calculations of desired data. Desired data is set in the pipeline registers 1, 2, and 3 (60, 70, and 80) at the rising edge of the clock signal at time T2. The instruction code of the interrupt instruction is stored in the instruction fetch register 140 at the rising edge of the clock signal at time T2. The period between times T1 and T2 corresponds to the instruction execution stage of the instruction preceding the interrupt instruction and the instruction fetch stage of the interrupt instruction.

The value of the program counter 20 is incremented by two (+2) at the rising edge of the clock signal at time T2. As a result, the address where the instruction code of the instruction subsequent to the interrupt instruction is stored is set in the program counter 20 so that the instruction code of the instruction subsequent to the interrupt instruction is read from the ROM 30. The pipeline control section 300 decodes the instruction code (instruction code of the interrupt instruction) stored in the instruction fetch register 140 in the period between times T2 and T3, and generates the control signals 322-1 to 322-m based on the decoding results. Specifically, the pipeline control section 300 (decoding section 310) decodes the instruction code of the interrupt instruction, and generates the vector code 312 corresponding to the interrupt cause. The immediate generation section 100 combines the value of the TTBR 120 with the value of the vector code 312, and adds zero to the lower-order two bits of the resulting data to generate the vector address. In the period between times T2 and T3, the pipeline control section 3 (control signal generation section 320) generates the selection signals supplied to the selectors 54 and 76 so that the output (vector address) from the immediate generation section 100 is input to the input of the pipeline register 1 (60), generates the selection signals supplied to the selectors 64 and 66 so that the output from the stack pointer 50 is input to the input of the pipeline register 2 (70), and generates the selection signal supplied to the selector 84 so that the constant value 4 is input to the input of the pipeline register 3 (80). The pipeline control section 300 (control signal generation section 320) generates the selection signal so that the selector 24 selects the output from the program counter 20. The value of the program counter 20 is input to the output of the selector 24. The pipeline control section 300 (control signal generation section 320) does not generate the selection signal so that the selector 24 selects the output from the incrementer 40, different from the period between times T0 and T2, to save the address where the instruction code of the instruction subsequent to the interrupt instruction is stored in the stack area 210 in order to again fetch the instruction subsequent to the interrupt instruction after completion of interrupt handling, as described later. The vector address, the value of the stack pointer 50, and the constant value 4 are respectively set in the pipeline registers 1, 2, and 3 (60, 70, and 80) at the rising edge of the clock signal at time T3. When the instruction preceding the interrupt instruction is an arithmetic calculation instruction, the output from the ALU 90 is stored in the general-purpose register R0 at the rising edge of the clock signal at time T3, for example. The pipeline control section 300 (control signal generation section 320) prevents the instruction code of the instruction subsequent to the interrupt instruction code from being fetched in the instruction fetch register 140 at the rising edge of the clock signal at time T3. The period between times T2 and T3 corresponds to the second instruction execution stage of the instruction preceding the interrupt instruction and the first instruction execution stage of the interrupt instruction.

The pipeline control section 300 (control signal generation section 320) generates the control signals 322-1 to 322-m based on the decoding result and the execution state of the interrupt instruction in the period between times T3 and T4. Specifically, the pipeline control section 300 (control signal generation section 320) generates the selection signal so that the ALU 90 executes subtraction, and generates the control signal so that the data output from the RAM 200 is supplied to the general-purpose data bus 150. The ALU 90 subtracts the value of the pipeline register 2 (70) from the value of the pipeline register 3 (80), and outputs the subtraction result (value obtained by subtracting four from the value of the stack pointer 50). The branch destination address is read from the vector table 220 of the RAM 200 based on the vector address designated by the pipeline register 1 (60), and is supplied to the general-purpose data bus 150. In the period between times T3 and T4, the pipeline control section 300 (control signal generation section 320) generates the selection signals supplied to the selectors 54 and 76 so that the output from the ALU 90 is input to the input of the stack pointer 50 and the input of the pipeline register 1 (60), generates the selection signal supplied to the selector 66 so that the output from the program counter 20 is input to the input of the pipeline register 2 (70), and generates the selection signal supplied to the selector 24 so that the data on the general-purpose data bus 150 is input to the input of the program counter 20. The value −4 of the stack pointer 50 is set in the stack pointer 50 and the pipeline register 1 (60), and the value of the program counter 20 (address where the instruction code of the instruction subsequent to the interrupt instruction is stored) is set in the pipeline register 2 (70) at the rising edge of the clock signal at time T4. The data (branch destination address) on the general-purpose data bus 150 is set in the program counter 20 at the rising edge of the clock signal at time T4. The pipeline control section 300 (control signal generation section 320) prevents the instruction code of the instruction subsequent to the interrupt instruction code from being fetched in the instruction fetch register 140 at the rising edge of the clock signal at time T4. The period between times T3 and T4 corresponds to the second instruction execution stage of the interrupt instruction.

The pipeline control section 300 (control signal generation section 320) generates the control signals 322-1 to 322-m based on the decoding result and the execution state of the interrupt instruction in the period between times T4 and T5. Specifically, the pipeline control section 300 (control signal generation section 320) generates the selection signal so that the output from the pipeline register 2 (70) and the output from the state register 110 are supplied to the general-purpose data bus 150, and generates the write enable signal for the RAM 200. The pipeline control section 300 (control signal generation section 320) generates the selection signal supplied to the selector 24 so that the output from the incrementer 40 is input to the input of the program counter 20. The value of the pipeline register 2 (70) (address where the instruction code of the instruction subsequent to the interrupt instruction is stored) and the value of the state register 110 are set in the data input to the RAM 200 and the output from the pipeline register 1 (60) (stack pointer 50) is set as the address of the RAM 200 at the rising edge of the clock signal at time T5 so that data is written into the RAM 200. As a result, the address where the instruction code of the instruction subsequent to the interrupt instruction is stored and the value of the state register 110 are saved in the stack area 210 of the RAM 200. The instruction cede of the instruction (branch instruction) stored at the branch destination address is stored in the instruction fetch register 140 at the rising edge of the clock signal at time T5. The period between times T4 and T5 corresponds to the third instruction execution stage of the interrupt instruction and the instruction fetch stage of the branch instruction.

The value of the program counter 20 is incremented by two (+2) at the rising edge of the clock signal at time T5. As a result, the address where the instruction code of the instruction subsequent to the branch instruction is stored is set in the program counter 20 so that the instruction code of the instruction subsequent to the branch instruction is read from the ROM 30. The pipeline control section 300 (control signal generation section 320) decodes the instruction code (instruction code of the branch instruction) stored in the instruction fetch register 140 in the period between times T5 and T6, and generates the control signals 322-1 to 322-m based on the decoding results. The instruction code of the instruction subsequent to the branch instruction is stored in the instruction fetch register 140 at the rising edge of the clock signal at time T6. The period between times T5 and T6 corresponds to the first instruction execution stage of the branch instruction and the instruction fetch stage of the instruction subsequent to the branch instruction. A branch destination interrupt handling program is then executed.

As described above, the microprocessor according to this embodiment can execute an interrupt instruction in three clock cycles (first to third instruction execution stages).

FIG. 6 is a diagram illustrative of an operation of saving the values of the program counter and the state register in the stack area when executing an interrupt. The operation shown in FIG. 6 is described below with reference to FIGS. 1 and 5.

The stack area 210 is included in the RAM 200 mapped at 0x000000 to 0x007FFF in the 24-bit address space. The stack area 210 is a 256-byte storage area mapped at 0x007F00 to 0x007FFF, for example. Before executing an interrupt instruction (period between times T0 to T2 in FIG 5), the value of the stack pointer (SP) 50 is 0x007F14 (i.e., the stack pointer (SP) 50 indicates the storage area 211 assigned to the address 0x007F14). Since the lower-order two bits of the address 0x007F14 are 00, the address 0x007F14 indicates the word boundary (32-bit boundary). As described with reference to FIG. 5, a value (0x007F10) obtained by subtracting four from the value of the stack pointer 50 is set at the end (time T4) of the second instruction execution stage when executing the interrupt instruction. Since the lower-order two bits of the address 0x007F10 are 00, the address 0x007F10 indicates the word boundary (32-bit boundary). In the third instruction execution stage (period between times T4 and T5), the output from the program counter 20 and the output from the state register 110 are supplied to the general-purpose data bus 150. For example, the 24-bit output (PC[23:0]) from the program counter 20 and the 8-bit output (PSR[7:0]) from the state register 110 are supplied to the lower-order 24 bits and the higher-order eight bits of the 32-bit data bus. The 32-bit data supplied to the general-purpose data bus 150 is saved at the address 0x007F10 of the stack area at the end (time T5) of the third instruction execution stage. Specifically, the 32-bit data is divided in 1-byte (8-bit) units, and the data PC[7:0], PC[15:8], PC[23:16], and PSR[7:0] are stored in storage areas 211 to 214 assigned to addresses 0x007F10 to 0x007F14, respectively. Since the 32-bit width of the input data bus of the RAM 200 is not exceeded even if the 24-bit width of the program counter 20 and the 8-bit width of the state register 110 are added, and word access is performed while designating the address 0x007F10 at the word boundary (32-bit boundary), the data can be saved in the stack area 210 in one clock cycle.

2. Microcomputer

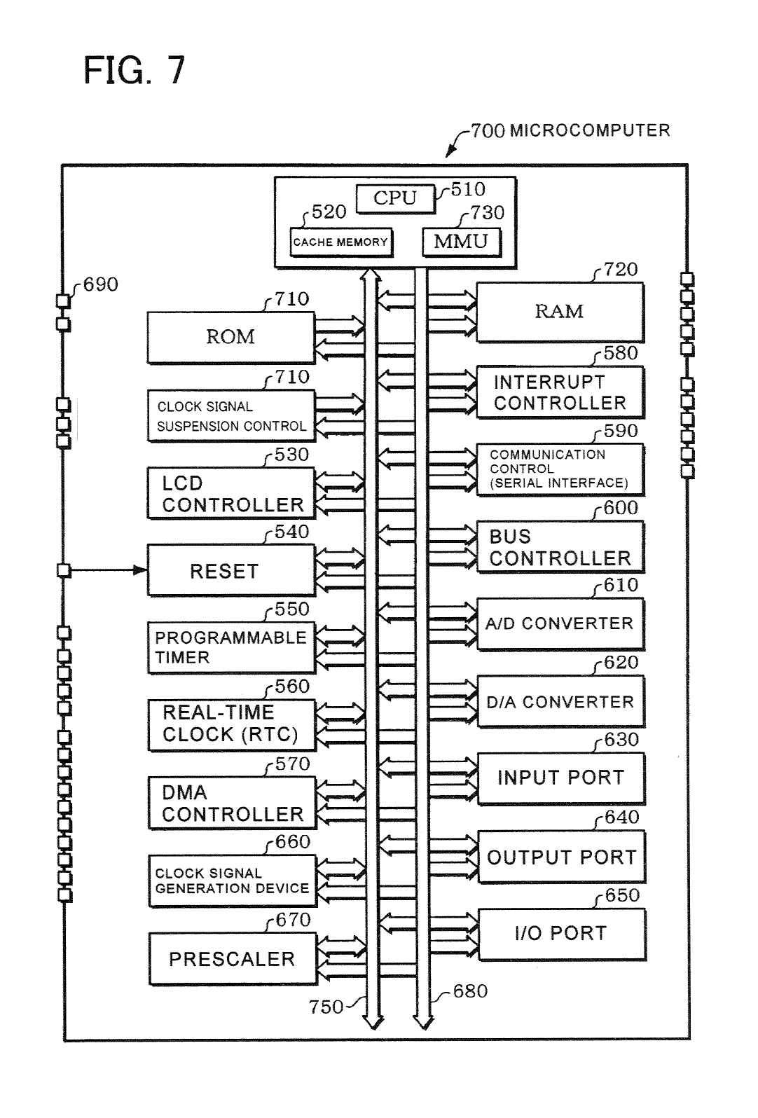

FIG. 7 shows an example of a hardware block diagram of a microcomputer according to one embodiment of the invention.

A microcomputer 700 includes a CPU 510 (microprocessor according to the above embodiment), a cache memory 520, a ROM 710, a RAM 720, an MMU 730, an LCD controller 530, a reset circuit 540, a programmable timer 550, a real-time clock (RTC) 560, a DMA controller 570, an interrupt controller 580, a communication control circuit 590, a bus controller 600, an A/D converter 610, a D/A converter 620, an input port 630, an output port 640, an I/O port 650, a clock signal generation device 660, a prescaler 670, a clock signal suspension control circuit 740, a general-purpose bus 680 and a dedicated bus 750 which connect these sections, pins 690, and the like.

3. Electronic instrument

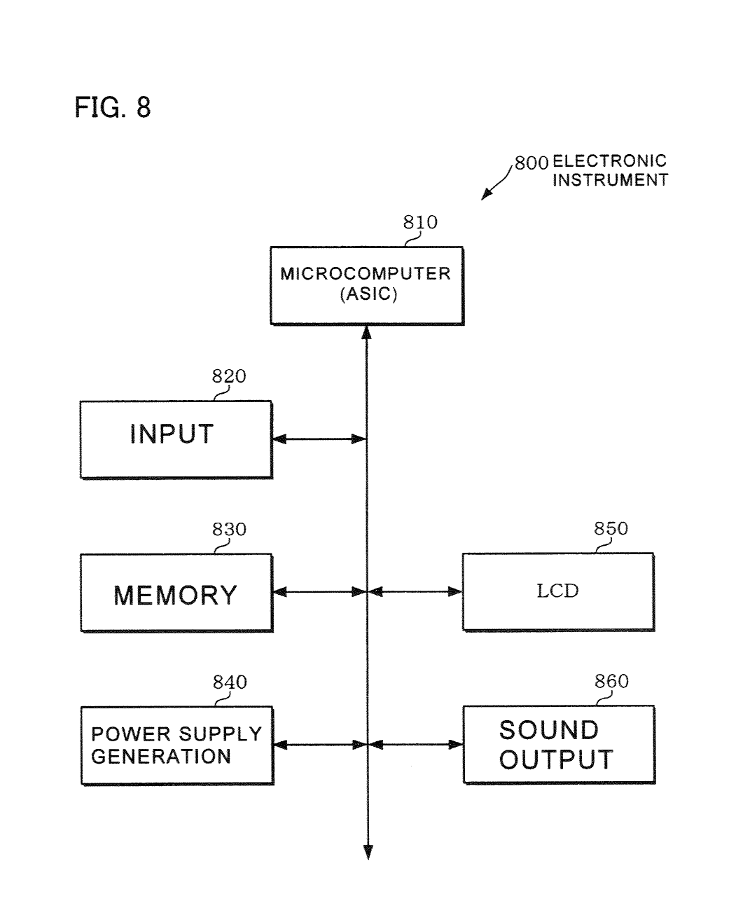

FIG. 8 shows an example of a block diagram of an electronic instrument according to one embodiment of the invention. An electronic instrument 800 includes a microcomputer (or ASIC) 810, an input section 820, a memory 830, a power generation section 840, an LCD 850, and a sound output section 860.

The input section 820 is used for inputting various types of data. The microcomputer 810 performs various processes based on data input using the input section 820. The memory 830 functions as a work area for the microcomputer 810 and the like. The power supply generation section 840 generates various power supply voltages used in the electronic instrument 800. The LCD 850 is used for outputting various images (e.g. character, icon, and graphic) displayed by the electronic instrument 800.

The sound output section 860 is used for outputting various types of sound (e.g. voice and game sound) output from the electronic instrument 800. The function of the sound output section 860 may be implemented by hardware such as a speaker.

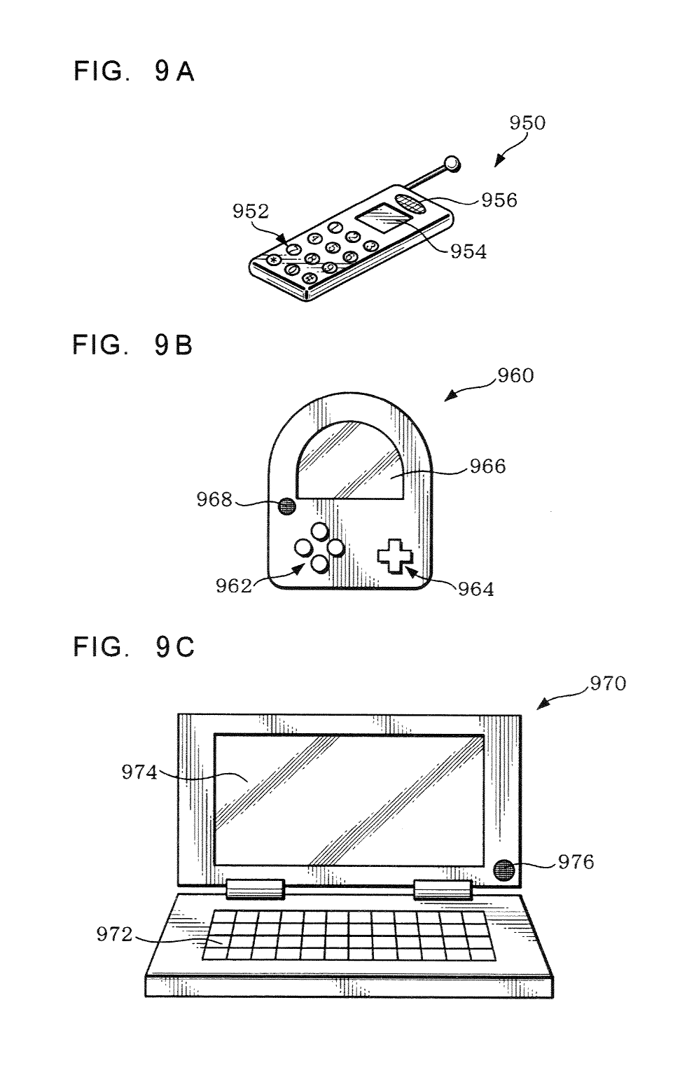

FIG. 9A shows an example of an outside view of a portable telephone 950 which is one type of electronic instrument. The portable telephone 950 includes dial buttons 952 which function as the input section, an LCD 954 which displays a telephone number, a name, an icon, and the like, and a speaker 956 which functions as the sound output section and outputs voice.

FIG. 9B shows an example of an outside view of a portable game device 960 which is one type of electronic instrument. The portable game device 960 includes operation buttons 962 which function as the input section, an arrow key 964, an LCD 966 which displays a game image, and a speaker 968 which functions as the sound output section and outputs game sound.

FIG. 9C shows an example of an outside view of a personal computer 970 which is one type of electronic instrument. The personal computer 970 includes a keyboard 972 which functions as the input section, an LCD 974 which displays a character, a figure, a graphic, and the like, and a sound output section 976.

An inexpensive electronic instrument exhibiting a high program response can be provided by incorporating the microcomputer according to the above embodiment in the electronic instruments shown in FIGS. 9A to 9C.

As examples of the electronic instrument to which the above embodiment can be applied, various electronic instruments using an LCD such as a personal digital assistant, a pager, an electronic desk calculator, a device provided with a touch panel, a projector, a word processor, a viewfinder or direct-viewfinder video tape recorder, and a car navigation system can be given in addition to the electronic instruments shown in FIGS. 9A, 9B, and 9C.

The invention is not limited to the above-described embodiments. Various modifications and variations may be made without departing from the scope of the invention.

For example, the part of the microprocessor according to this embodiment described with reference to FIG. 1 may have another configuration. For example, when the microprocessor 10 is connected to a coprocessor which executes complicated calculations (e.g., multiplication) at high speed, the output of the coprocessor may be connected to the input of the selector 54, or the outputs of the pipeline registers 2 and 3 (70 and 80) may be connected to each data input of the coprocessor.

A configuration may also be employed in which a pipeline register 4 (fourth pipeline register) is additionally provided, the pipeline register 2 (70) is exclusively used for setting the input data of the ALU 90, and the pipeline register 4 is exclusively used for setting the address of the RAM 200, for example. In this case, the description given with reference to FIG. 5 may be similarly applied by storing the value of the program counter 20 in the pipeline register 4 at time T4 in FIG. 5 instead of storing the value of the program counter 20 in the pipeline register 2 (70), and saving the value of the pipeline register 4 in the stack area at time T5 instead of saving the value of the pipeline register 2 (70) in the stack area.

For example, the output of the incrementer 40 may be connected to one input of the selector 66 instead of the output of the program counter 20. In this case, the description given with reference to FIG. 5 may be similarly applied by storing the value output from the incrementer 40 in the pipeline register 2 (70) at time T4 in FIG. 5 instead of the value of the program counter 20.

For example, the vector address may be generated by the ALU 90 in the first instruction execution stage of the interrupt instruction. For example, a 2-to-1 selector is inserted between the output of the pipeline register 2 (70) and the first input of the ALU 90. The output of the pipeline register 2 (70) is connected to one input of the 2-to-1 selector, and the output of the TBR 120 is connected to the other input of the 2-to-1 selector. A 2-to-1 selector is also inserted between the output of the pipeline register 3 (80) and the second input of the ALU 90. The output of the pipeline register 3 (80) is connected to one input of the 2-to-1 selector, and the vector code 312 is supplied to the other input of the 2-to-1 selector. In this case, the pipeline control section 300 (control signal generation section 320) may generate the selection signals so that these 2-to-1 selectors respectively select the output from the TTBR 120 and the vector code 312, generate the control signal so that the ALU 90 executes addition, and generate the selection signals supplied to the selectors 54 and 76 so that the output (vector address) from the ALU 90 is input to the input of the pipeline register 1 (60) in the period between times T2 and T3 in FIG. 5, for example. The pipeline control section 300 (control signal generation section 320) may generate the selection signals so that these 2-to-1 selectors respectively select the pipeline registers 2 and 3 (70 and 80), and generate the control signal so that the ALU 90 executes subtraction in the period between times T3 and T4.

FIG. 5 shows the operation when the microprocessor according to this embodiment handles a software interrupt. The same description also applies to the case where the microprocessor according to this embodiment handles a hardware interrupt. When the microprocessor handles a hardware interrupt, the process after time T2 may be similarly applied by adding a process which detects occurrence of a hardware interrupt at time T1, and replacing the process which reads an interrupt instruction from the ROM 30 in the instruction fetch stage in the period between times T1 and T2 by a process in which the interrupt instruction generation section generates an instruction cede of an interrupt instruction containing the interrupt causes INT0 to INT31.

The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A microprocessor which executes an instruction having an instruction code stored in a memory and has a function of performing a pipeline process including an instruction fetch stage for fetching the instruction code and an instruction execution stage for executing the instruction, the microprocessor comprising:
a pipeline control section which controls the pipeline process;
a program counter used for referring to a storage location of the instruction code;
a general-purpose arithmetic logic unit which executes an arithmetic calculation based on at least two inputs;
a stack pointer used for referring to a stack area in which a value of the program counter is saved;
a first pipeline register used for setting an address of a memory storing information relating to a branch destination address corresponding to an interrupt instruction which is executed by a plurality of instruction execution stages;
a second pipeline register used for setting a first input to the arithmetic logic unit; and
a third pipeline register used for setting a second input to the arithmetic logic unit,
wherein, in a first instruction execution stage of the interruption instruction, the pipeline control section decodes the instruction code of the interrupt instruction and causes a vector address for referring to the information relating to the branch destination address corresponding to the interrupt instruction to be generated based on a decoding result of the interrupt instruction; and
wherein the pipeline control section controls the pipeline process so that the vector address is set in the first pipeline register, the value of the stack pointer is set in the second pipeline register, and a predetermined constant value is set in the third pipeline register at the end of the first instruction execution stage of the interrupt instruction.

2. The microprocessor as defined in claim 1, further comprising:
an immediate generation section which generates an immediate address or immediate data,
the pipeline control section causing the immediate generation section to generate the vector address in the first instruction execution stage of the interrupt instruction.

3. The microprocessor as defined in claim 2, further comprising:
a signal path connecting an output of the immediate generation section and an input of the first pipeline register;
a signal path connecting an output of the first pipeline register and an address input of the memory storing the information relating to the branch destination address;
a signal path connecting an output of the stack pointer and an input of the second pipeline register;
a signal path connecting an output of the second pipeline register and the first input of the arithmetic logic unit;
a signal path connecting a supply source of the predetermined constant value and an input of the third pipeline register; and
a signal path connecting an output of the third pipeline register and the second input of the arithmetic logic unit.

4. The microprocessor as defined in claim 1, further comprising:
a general-purpose data bus,
wherein an nth (n is 1, 2, or 3) pipeline register among the first to the third pipeline registers is used for supplying data to at least part of the general-purpose data bus;
wherein the pipeline control section causes the arithmetic logic unit to execute an arithmetic calculation based on the value of the stack pointer and the predetermined constant value in a second instruction execution stage of the interrupt instruction; and
wherein the pipeline control section controls the pipeline process so that a result of the arithmetic calculation is set in the stack pointer, the value of the program counter is set in the nth pipeline register, and the information relating to the branch destination address referred to by the vector address is set in the program counter at the end of the second instruction execution stage of the interrupt instruction.

5. The microprocessor as defined in claim 2, further comprising:
a general-purpose data bus,
wherein an nth (n is 1, 2, or 3) pipeline register among the first to the third pipeline registers is used for supplying data to at least part of the general-purpose data bus;
wherein the pipeline control section causes the arithmetic logic unit to execute an arithmetic calculation based on the value of the stack pointer and the predetermined constant value in a second instruction execution stage of the interrupt instruction; and
wherein the pipeline control section controls the pipeline process so that a result of the arithmetic calculation is set in the stack pointer, the value of the program counter is set in the nth pipeline register, and the information relating to the branch destination address referred to by the vector address is set in the program counter at the end of the second instruction execution stage of the interrupt instruction.

6. The microprocessor as defined in claim 3, further comprising:
a general-purpose data bus,
wherein an nth (n is 1, 2, or 3) pipeline register among the first to the third pipeline registers is used for supplying data to at least part of the general-purpose data bus;
wherein the pipeline control section causes the arithmetic logic unit to execute an arithmetic calculation based on the value of the stack pointer and the predetermined constant value in a second instruction execution stage of the interrupt instruction; and
wherein the pipeline control section controls the pipeline process so that a result of the arithmetic calculation is set in the stack pointer, the value of the program counter is set in the nth pipeline register, and the information relating to the branch destination address referred to by the vector address is set in the program counter at the end of the second instruction execution stage of the interrupt instruction.

7. The microprocessor as defined in claim 4, further comprising:
a signal path connecting an output of the program counter and an input of the nth pipeline register; and
a signal path connecting an output of the nth pipeline register and the at least part of the general-purpose data bus.

8. The microprocessor as defined in claim 5, further comprising:
a signal path connecting an output of the program counter and an input of the nth pipeline register; and
a signal path connecting an output of the nth pipeline register and the at least part of the general-purpose data bus.

9. The microprocessor as defined claim 1, further comprising:
a general-purpose data bus;
a fourth pipeline register used for supplying data to at least part of the general-purpose data bus;
a signal path connecting an output of the program counter and an input of the fourth pipeline register; and
a signal path connecting an output of the fourth pipeline register and the at least part of the general-purpose data bus,
wherein the pipeline control section causes the arithmetic logic unit to execute an arithmetic calculation based on the value of the stack pointer and the predetermined constant value in a second instruction execution stage of the interrupt instruction; and
wherein the pipeline control section controls the pipeline process so that a result of the arithmetic calculation is set in the stack pointer, the value of the program counter is set in the fourth pipeline register, and the information relating to the branch destination address referred to by the vector address is set in the program counter at the end of the second instruction execution stage of the interrupt instruction.

10. The microprocessor as defined claim 2, further comprising:
a general-purpose data bus;
a fourth pipeline register used for supplying data to at least part of the general-purpose data bus;
a signal path connecting an output of the program counter and an input of the fourth pipeline register; and
a signal path connecting an output of the fourth pipeline register and the at least part of the general-purpose data bus,
wherein the pipeline control section causes the arithmetic logic unit to execute an arithmetic calculation based on the value of the stack pointer and the predetermined constant value in a second instruction execution stage of the interrupt instruction; and
wherein the pipeline control section controls the pipeline process so that a result of the arithmetic calculation is set in the stack pointer, the value of the program counter is set in the fourth pipeline register, and the information relating to the branch destination address referred to by the vector address is set in the program counter at the end of the second instruction execution stage of the interrupt instruction.

11. The microprocessor as defined in claim 4, further comprising:
a state register which indicates a state of the microprocessor,
the pipeline control section controlling the pipeline process so that the value of the program counter set in the pipeline register and a value of the state register are written into the stack area in a third instruction execution stage of the interrupt instruction.

12. The microprocessor as defined in claim 9, further comprising:
a state register which indicates a state of the microprocessor,
the pipeline control section controlling the pipeline process so that the value of the program counter set in the pipeline register and a value of the state register are written into the stack area in a third instruction execution stage of the interrupt instruction.

13. The microprocessor as defined in claim 11, further comprising:
a signal path connecting an output of the state register and the at least part of the general-purpose data bus; and
a signal path connecting the general-purpose data bus and a data input of a memory having the stack area.

14. The microprocessor as defined in claim 12, further comprising:
a signal path connecting an output of the state register and the at least part of the general-purpose data bus; and
a signal path connecting the general-purpose data bus and a data input of a memory having the stack area.

15. The microprocessor as defined in claim 11,
the program counter having a bit width of i bits (i is an integer equal to or larger than one);
the state register having a bit width of j bits (j is an integer equal to or larger than one);
a memory having the stack area having an input data bus with a k-bit width (k is an integer equal to or larger than one); and
k being equal to or larger than i+j.

16. The microprocessor as defined in claim 12,
the program counter having a bit width of i bits (i is an integer equal to or larger than one);
the state register having a bit width of j bits (j is an integer equal to or larger than one);
a memory having the stack area having an input data bus with a k-bit width (k is an integer equal to or larger than one); and
k being equal to or larger than i+j.

17. The microprocessor as defined in claim 11, a memory having the stack area having an input data bus with a k-bit width (k is an integer equal to or larger than one); and
the stack pointer referring to the stack area by designating an address of a k-bit boundary.

18. The microprocessor as defined in claim 12,
a memory having the stack area having an input data bus with a k-bit width (k is an integer equal to or larger than one); and
the stack pointer referring to the stack area by designating an address of a k-bit boundary.

19. A microcomputer comprising the microprocessor as defined in claim 1.

20. An electronic instrument comprising:
the microcomputer as defined in claim 19;
an input section which inputs data to be processed by the microcomputer; and
an output section which outputs the data processed by the microcomputer.
